(19) United States
(12) Patent Application Publication
(10) Pub. No.: US 2026/0236603 A1
(43) Pub. Date: Aug. 13, 2026

(54) SYSTEM AND METHOD FOR GOVERNANCE OF AI AGENTS

(71) Applicant: Zypero Intellect Pte. Ltd., Singapore (SG)

(72) Inventor: Dilip Visanji DAND, Brooklyn, NY (US)

(21) Appl. No.: 19/636,063

(22) Filed: Apr. 1, 2026

(51) Int. Cl. G06F 21/62

(52) U.S. Cl. CPC G06F 21/6227

(57) ABSTRACT

A system for governance of an artificial intelligence (AI) agent in a production environment is disclosed. The system comprises one or more processors and a memory storing instructions to perform operations including receiving execution artifacts generated by the AI agent, decomposing the execution artifacts into a hierarchical structure comprising activities and steps, and generating evaluation prompts conforming to a predefined evaluation schema for each step. The system transmits evaluation prompts to an independent evaluator model distinct from the AI agent and receives structured evaluation signal records. A signal validator validates each record against the schema. A deterministic step scoring engine computes a step-level score by applying a trust adjustment derived from risk indicator values to a composite performance score derived from a quality score and an outcome-alignment score. The system applies asymmetric policy-defined risk penalty weights wherein compliance and security penalties exceed hallucination penalties.

### TECHNICAL FIELD

The present disclosure relates to artificial intelligence agent monitoring and governance, and more particularly, the disclosure relates to a system and method for deterministic, schema-driven governance of AI agents to produce multi-level behavioral assessments consumable by automated governance platforms.

### BACKGROUND

Enterprise computing environments increasingly deploy AI agents across operational workflows including customer service automation, decision support, content generation, and task orchestration. These AI agents typically comprise large language models or other generative models that receive user inputs, invoke tools or application programming interfaces, and produce natural language outputs or structured actions. Observability platforms have emerged to monitor such deployed agents by collecting infrastructure-level telemetry such as request latency, token consumption, uptime statistics, and error rates. Evaluation approaches that use a secondary language model as a judge have also been explored to assess output quality of AI agent responses on a per-interaction basis.

However, existing monitoring and evaluation architectures face several technical limitations that prevent reliable behavioral governance of AI agents at production scale. Infrastructure-level telemetry measures computational resource utilization but does not capture whether an AI agent is producing outputs that align with intended operational outcomes, such as task completion, procedural correctness, or compliance adherence. The AI agent may exhibit stable latency, consistent token throughput, and zero infrastructure errors while simultaneously producing outputs that contain hallucinated content, deviate from compliance policies, or fail to resolve user requests, a class of silent behavioral degradation invisible to conventional observability systems. Evaluation approaches that rely on an unconstrained language model acting as a judge introduce non-determinism into the evaluation pipeline: repeated evaluations of the same agent output may yield different scores, different rationale texts, and different risk assessments, making such evaluations unsuitable for audit-grade governance. Furthermore, existing systems lack a mechanism to separate quality assessment, operational outcome alignment, and risk exposure into distinct evaluation categories that can be independently weighted, aggregated, and penalized according to configurable policies. The absence of a trust adjustment mechanism that applies policy-driven risk penalties: where compliance and security risks are penalized more heavily than other risk categories and prevents existing systems from generating risk-aware scores that reflect true behavioral accountability. Additionally, no existing architecture provides a deterministic pipeline for aggregating step-level scores into activity-level trust metrics using recency-weighted aggregation, nor for detecting behavioral drift across multiple time horizons and mapping aggregated signals into discrete, machine-interpretable behavioral states suitable for automated enforcement.

Accordingly, there is a need for a system and method that transforms unstructured AI agent execution artifacts into structured, risk-aware behavioral assessments using a deterministic scoring architecture.

### SUMMARY

This summary introduces concepts related to systems and methods for behavioral governance of an AI agent. The concepts are further described in the detailed description. This summary is not intended to identify essential features of the claimed subject matter nor limit its scope.

In one aspect, the present disclosure provides a system for governance of an artificial intelligence (AI) agent. The system comprises one or more processors and a memory coupled to the one or more processors. The memory stores instructions executable by the one or more processors to perform operations. The operations comprise receiving a plurality of execution artifacts generated by the AI agent during an interaction. The operations further comprise decomposing the plurality of execution artifacts into a hierarchical structure, wherein the hierarchical structure comprises at least one activity and a plurality of steps within the at least one activity, and wherein each step corresponds to a discrete output or a discrete action produced by the AI agent within the at least one activity. For each step of the plurality of steps, the operations comprise generating an evaluation prompt based on step-level execution artifacts associated with the step, the evaluation prompt conforming to a predefined evaluation schema retrieved from an evaluation schema repository and requiring a structured output, wherein the structured output comprises a plurality of normalized evaluation signals for the step. The operations comprise transmitting the evaluation prompt and the step-level execution artifacts to an independent evaluator model distinct from the AI agent, and receiving, from the independent evaluator model, a structured evaluation signal record for the step. The operations further comprise validating the structured evaluation signal record against the predefined evaluation schema, and upon a validation failure, initiating a corrective action comprising at least one of a retry request to the independent evaluator model and a confidence reduction for the structured evaluation signal record that failed the validation. The operations comprise computing a step-level score for the step by applying a trust adjustment derived from a plurality of risk indicator values to a composite performance score, the composite performance score being derived from at least a quality score and an outcome-alignment score extracted from the structured evaluation signal record. The operations further comprise storing, in a data repository, the step-level score together with an evaluator confidence value associated with the structured evaluation signal record and an audit trail linking the step-level score to the structured evaluation signal record.

In another aspect, the present disclosure provides a system for generating risk-adjusted activity-level trust metrics for an AI agent. The system comprises one or more processors and a memory coupled to the one or more processors. The memory stores instructions executable by the one or more processors to perform operations. The operations comprise receiving a plurality of step-level score records for a plurality of steps within an activity of the AI agent, each step-level score record comprising a step-level score, an evaluator confidence value, and a plurality of risk indicator values, the step-level score having been computed by applying a trust adjustment derived from the plurality of risk indicator values to a composite performance score, the composite performance score being derived from at least a quality score and an outcome-alignment score. The operations comprise ordering the plurality of step-level score records according to a temporal sequence corresponding to an execution order of the plurality of steps within the activity. The operations further comprise computing, by an activity aggregator, an activity-level score for the activity by applying a recency-weighted aggregation to the plurality of step-level scores, the recency-weighted aggregation assigning a higher weight to a step-level score occurring later in the temporal sequence relative to a step-level score occurring earlier in the temporal sequence, wherein the recency-weighted aggregation uses a decay factor applied to each step-level score based on a temporal position of the corresponding step within the activity. The operations comprise generating an activity score record comprising the activity-level score, a count of the plurality of steps, a recency weighting parameter, an aggregated risk indicator derived from the plurality of risk indicator values, and an aggregated evaluator confidence derived from the plurality of evaluator confidence values. The operations further comprise storing the activity score record in a data repository linked to an agent identifier and an activity identifier.

In yet another aspect, the present disclosure provides a method for governance of an artificial intelligence (AI) agent. The method comprises receiving, by one or more processors, a plurality of execution artifacts generated by the AI agent during an interaction. The method comprises decomposing, by the one or more processors, the plurality of execution artifacts into a hierarchical structure, wherein the hierarchical structure comprises at least one activity and a plurality of steps within the at least one activity, and wherein each step of the plurality of steps corresponds to a discrete output or a discrete action produced by the AI agent within the at least one activity. For each step of the plurality of steps, the method comprises generating, by the one or more processors, an evaluation prompt based on step-level execution artifacts associated with the step, the evaluation prompt conforming to a predefined evaluation schema and requiring a structured output comprising a plurality of normalized evaluation signals for the step. The method comprises transmitting the evaluation prompt and the step-level execution artifacts to an independent evaluator model distinct from the AI agent, and receiving, from the independent evaluator model, a structured evaluation signal record for the step. The method comprises validating, by the one or more processors, the structured evaluation signal record against the predefined evaluation schema, and upon a validation failure, initiating a corrective action comprising at least one of a retry request to the independent evaluator model and a confidence reduction for the structured evaluation signal record that failed the validation. The method comprises computing, by the one or more processors, a step-level score for the step by applying a trust adjustment derived from a plurality of risk indicator values to a composite performance score, the composite performance score being derived from at least a quality score and an outcome-alignment score extracted from the structured evaluation signal record. The method comprises storing, in a data repository, the step-level score together with an evaluator confidence value associated with the structured evaluation signal record and an audit trail linking the step-level score to the structured evaluation signal record.

Embodiments disclosed herein provide several technical advantages over conventional AI agent monitoring and evaluation systems. The disclosed architecture improves computational determinism in AI agent evaluation by constraining a non-deterministic evaluator model output through schema-enforced structured signal extraction, schema-based validation with automated retry and confidence reduction corrective actions, and deterministic rule-based scoring thereby transforming variable evaluator model outputs into repeatable, audit-grade step-level scores. Processing efficiency is enhanced through hierarchical decomposition of execution artifacts into discrete steps that are independently scored and selectively aggregated, avoiding redundant re-evaluation of entire interaction sessions when only individual steps require assessment. The trust adjustment mechanism provides an unconventional risk-penalization approach that applies asymmetric policy-defined penalty weights where compliance and security risk penalties exceed hallucination risk penalties to the composite performance score, producing risk-aware step-level scores that reflect policy-driven behavioral accountability not achievable through uniform risk weighting. The recency-weighted activity-level aggregation using a configurable decay factor provides a temporally sensitive trust metric that assigns greater influence on later steps within an activity, capturing the cumulative contextual dependency of sequential AI agent interactions more accurately than uniform averaging. These improvements enable automated, programmatic behavioral governance of AI agents at production scale without requiring access to model weights, embeddings, or training pipelines of the monitored AI agent.

### BRIEF DESCRIPTION OF DRAWINGS

The accompanying drawings, which are incorporated in and constitute a part of this specification, illustrate embodiments and together with the description, serve to explain the principles of the disclosure.

FIG. 1 is a block diagram illustrating a system architecture for governance of an AI agent in a production environment.

FIG. 2 is a detailed block diagram showing internal components of the governance system of FIG. 1.

FIG. 3 is a flowchart illustrating a method for step-level governance of an AI agent.

FIG. 4 is a flow diagram showing activity-level and time-window aggregation of step-level scores.

FIG. 5 is a flowchart depicting drift detection and behavioral state generation for an AI agent; and

FIG. 6 is a flow diagram illustrating hybrid confirmation logic for reconciling semantic and system-verified operational outcome indicators.

### DETAILED DESCRIPTION

The following detailed description references the accompanying drawings that illustrate specific embodiments in which the invention may be practiced. The embodiments are intended to describe aspects of the invention in sufficient detail to enable those skilled in the art to practice the invention. Other embodiments may be utilized, and changes may be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, or other element described in one embodiment may also be included in other embodiments but is not necessarily included. Thus, the technology can include a variety of combinations and/or integrations of the embodiments described herein.

As used herein, unless otherwise stated, the term “approximately” means within ten percent of the stated value. The terms “comprising,” “including,” and “having” are intended to be inclusive and mean that there may be additional elements other than the listed elements. Singular forms include plural referents unless the context clearly dictates otherwise. The term “coupled” refers to a direct or indirect connection between components, whether electrical, communicative, logical, or otherwise.

The present disclosure relates to computer-implemented systems and methods for behavioral governance of artificial intelligence (AI) agents operating in production environments. Embodiments address technical challenges in monitoring and evaluating AI agent behavior where existing infrastructure-level observability systems fail to detect silent behavioral degradation—a class of failure in which an AI agent produces increasingly poor, risky, or non-compliant outputs while infrastructure telemetry metrics such as latency, token throughput, and uptime remain within normal bounds. The disclosed systems and methods provide a deterministic, schema-driven evaluation architecture that decomposes AI agent executions into hierarchically structured evaluation units, extracts normalized evaluation signals via an independent evaluator model constrained by a predefined schema, validates and scores those signals using deterministic rules with policy-driven risk penalty weighting, and produces step-level, activity-level, and agent-level trust metrics consumable by downstream governance platforms for automated enforcement—all without requiring access to the AI agent's internal model weights, embeddings, or training pipelines.

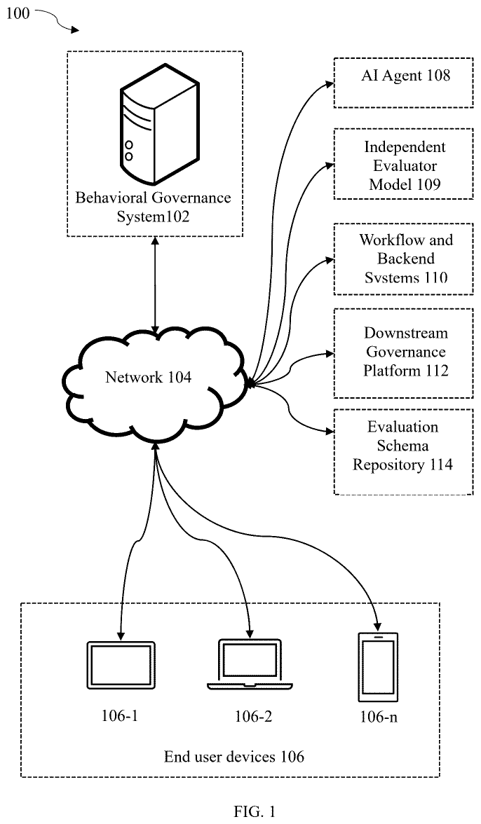

Referring now to FIG. 1, a network architecture (100) for behavioral governance of an AI agent in a production environment is illustrated according to one embodiment. The network architecture (100) depicts a behavioral governance system (102) communicatively coupled to a plurality of external entities via a network (104). The behavioral governance system (102) is the primary system being claimed and is configured to receive execution artifacts from an AI agent, evaluate those artifacts using an independent evaluator model under schema constraints, compute deterministic risk-adjusted scores, and generate trust metrics and behavioral state outputs for consumption by governance platforms.

The network (104) may comprise one or more of the Internet, a local area network (LAN), a wide area network (WAN), a wireless network such as Wi-Fi or cellular 4G/5G, a virtual private network (VPN), or any combination thereof. In some embodiments, the network (104) supports communication protocols including TCP/IP, HTTP/HTTPS, WebSocket, gRPC, MQTT, or other protocols suitable for data transmission between the behavioral governance system (102) and the external entities. In some embodiments, the network (104) implements transport layer security (TLS) for encrypted communication between entities.

One or more user devices (106) are communicatively coupled to the network (104). The user devices (106) represent computing devices from which end users interact with the AI agent (108). The user devices (106) may include, but are not limited to, desktop computers, laptop computers, tablet devices, smartphones, wearable devices, Internet-of-Things (IoT) devices, or any other computing devices capable of network communication. In the illustrated embodiment, multiple user devices (106-1, 106-2, . . . , 106-N) are shown, where N represents any positive integer. A user operating a user device (106) initiates an interaction with the AI agent (108)—for example, by submitting a customer service query, requesting task automation, or engaging in a conversational workflow.

The AI agent (108) represents the target AI agent being monitored and governed by the behavioral governance system (102). The AI agent (108) is a software entity deployed in a production environment that receives user inputs and produces outputs, which may include natural language responses, structured data, tool invocations, application programming interface (API) calls, or other actions. In some embodiments, the AI agent (108) comprises a large language model (LLM) such as a transformer-based generative model. In other embodiments, the AI agent (108) may comprise a retrieval-augmented generation (RAG) system, a multi-agent orchestration framework, or any other AI-based system that processes inputs and generates outputs. The AI agent (108) may be provided by any model provider and may use any model version or architecture. The behavioral governance system (102) operates externally to the AI agent (108) and does not require access to model weights, embeddings, internal prompts, token usage data, or training pipelines of the AI agent (108). This external operation architecture enables the behavioral governance system (102) to evaluate AI agents from different model providers, of different model versions, and of different model architectures without modification to those agents.

An independent evaluator model (109) is communicatively coupled to the behavioral governance system (102) via the network (104). The independent evaluator model (109) is a separate model—distinct from the AI agent (108)—that the behavioral governance system (102) invokes to generate structured evaluation signals for each step of an AI agent interaction. In some embodiments, the independent evaluator model (109) is a large language model provided by a third-party model provider, invoked via an API call. The independent evaluator model (109) may be hosted by the same or a different model provider than the AI agent (108). In some embodiments, the independent evaluator model (109) is selected independently of the model provider, model version, or model architecture of the AI agent (108), enabling the behavioral governance system (102) to use any suitable evaluator model regardless of the AI agent being monitored. The independent evaluator model (109) receives evaluation prompts from the behavioral governance system (102) and returns structured evaluation signal records conforming to a predefined evaluation schema specified in the evaluation prompt.

Workflow and backend systems (110) are communicatively coupled to the behavioral governance system (102) via the network (104). The workflow and backend systems (110) represent enterprise infrastructure components that generate system-verified outcomes associated with AI agent interactions. In some embodiments, the workflow and backend systems (110) comprise one or more of a ticketing system (such as a customer relationship management platform), a case management system, a backend database, a workflow orchestration engine, an API gateway, or a service bus. The workflow and backend systems (110) provide operational outcome data—such as ticket status updates, case resolution indicators, backend database state changes, SLA timestamp records, escalation events, and API execution results—that the behavioral governance system (102) uses to derive system-verified operational outcome indicators for each step of an AI agent interaction.

A downstream governance platform (112) is communicatively coupled to the behavioral governance system (102) via the network (104). The downstream governance platform (112) represents an external governance, compliance, or monitoring system that consumes behavioral state outputs, trust metrics, alerts, and governance event records generated by the behavioral governance system (102).

An evaluation schema repository (114) is communicatively coupled to the behavioral governance system (102). In some embodiments, the evaluation schema repository (114) is an external database, while in other embodiments it is integrated within the behavioral governance system (102). The evaluation schema repository (114) stores evaluation schemas that define metric definitions, metric data types, normalization rules, weight configurations, risk policy parameters, confidence policy parameters, aggregation rules, and state-mapping rules. In some embodiments, the evaluation schema repository (114) stores a plurality of tenant-specific evaluation schemas, enabling multi-tenant operation where different tenants (organizations) may define different evaluation criteria, risk policies, and scoring configurations for their respective AI agents.

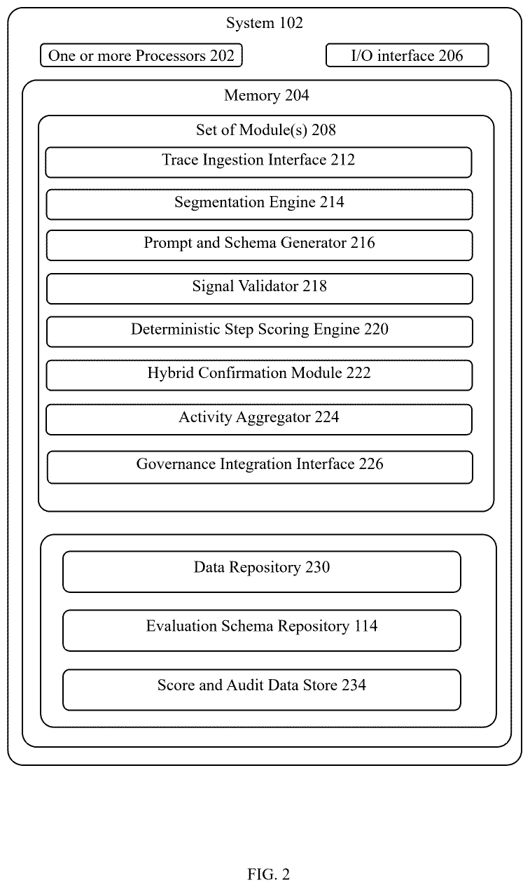

Referring now to FIG. 2, internal components of the behavioral governance system (102) are illustrated in greater detail according to one embodiment. As shown, the behavioral governance system (102) comprises one or more processors (202), a memory (204), an input/output (I/O) interface (206), a set of functional modules (208), and a data repository (230).

The one or more processors (202) may comprise a central processing unit (CPU), a graphics processing unit (GPU), a tensor processing unit (TPU), a field-programmable gate array (FPGA), an application-specific integrated circuit (ASIC), or any combination thereof. In some embodiments, the one or more processors (202) comprise multiple processing cores operating in parallel to enhance computational throughput. In some embodiments, the one or more processors (202) operate at clock speeds ranging from approximately 1 GHz to 5 GHz or higher, depending on the deployment hardware. The one or more processors (202) execute machine-readable instructions stored in the memory (204) to perform the operations described herein.

The memory (204) is coupled to the one or more processors (202) and stores executable instructions, data structures, evaluation schemas, model parameters, and intermediate computational results utilized by the behavioral governance system (102). In some embodiments, the memory (204) comprises volatile memory such as random-access memory (RAM), dynamic RAM (DRAM), or static RAM (SRAM) for active processing, and non-volatile memory such as read-only memory (ROM), flash memory, solid-state drives (SSD), or hard disk drives (HDD) for persistent storage. In some embodiments, the memory (204) has a capacity ranging from several gigabytes to multiple terabytes depending on the scale of deployment and the volume of AI agent interactions being governed. The memory (204) stores the set of functional modules (208) as executable code together with associated configuration data and runtime state.

The I/O interface (206) facilitates communication between the behavioral governance system (102) and external entities including the AI agent (108), the independent evaluator model (109), the workflow and backend systems (110), the downstream governance platform (112), and the evaluation schema repository (114). The I/O interface (206) may comprise network interface controllers (NICs), API gateways, message queue interfaces, webhook handlers, or other communication hardware and software. In some embodiments, the I/O interface (206) implements encryption protocols such as TLS/SSL for secure data transmission. The I/O interface (206) handles the transmission of evaluation prompts to the independent evaluator model (109) and the reception of structured evaluation signal records therefrom, as well as the reception of execution artifacts from the AI agent (108) and the transmission of behavioral states and governance events to the downstream governance platform (112).

The set of functional modules (208) comprises a plurality of specialized modules including a trace ingestion interface (212), a segmentation engine (214), a prompt and schema generator (216), a signal validator (218), a deterministic step scoring engine (220), a hybrid confirmation module (222), an activity aggregator (224), and a governance integration interface (226). Each module comprises executable instructions stored in the memory (204) and executed by the one or more processors (202) to perform specific functions. In some embodiments, the modules are implemented as microservices that can be independently deployed and scaled. In other embodiments, the modules are implemented as libraries or components within a monolithic application. The specific modular decomposition shown in FIG. 2 is one illustrative embodiment; other arrangements are within the scope of the invention.

In one embodiment, a system for governance of an artificial intelligence agent comprises one or more processors and a memory storing instructions that, when executed, cause the one or more processors to perform the following operations. The one or more processors receive a plurality of execution artifacts generated by the AI agent during an interaction, the execution artifacts comprising at least a user input, an agent output, tool invocation metadata, and contextual metadata. The one or more processors decompose the plurality of execution artifacts into a hierarchical structure comprising at least one activity and a plurality of steps within the at least one activity, wherein each step corresponds to an output or an action produced by the AI agent within the at least one activity. For each step, the one or more processors generate an evaluation prompt based on step-level execution artifacts associated with the step, the evaluation prompt conforming to a predefined evaluation schema retrieved from an evaluation schema repository and requiring a structured output comprising a plurality of normalized evaluation signals. The one or more processors transmit the evaluation prompt and the step-level execution artifacts to an independent evaluator model distinct from the AI agent and receive, from the independent evaluator model, a structured evaluation signal record for the step. The one or more processors validate the structured evaluation signal record against the predefined evaluation schema and, upon a validation failure, initiate a corrective action comprising at least one of a retry request to the independent evaluator model and a confidence reduction for the structured evaluation signal record that failed the validation, ensuring that unreliable evaluator outputs do not disproportionately influence subsequent scoring operations. The one or more processors compute a step-level score by applying a trust adjustment derived from a plurality of risk indicator values to a composite performance score, the composite performance score being derived from at least a quality score and an outcome-alignment score extracted from the structured evaluation signal record. The one or more processors store, in a data repository, the step-level score together with an evaluator confidence value associated with the structured evaluation signal record and an audit trail linking the step-level score to the structured evaluation signal record, thereby enabling traceability from any computed step-level score back to the originating structured evaluation signals for governance, audit, and dispute resolution purposes.

The trace ingestion interface (212) is configured to receive a plurality of execution artifacts generated by the AI agent (108) during an interaction. The trace ingestion interface (212) is communicatively coupled to the I/O interface (206) and receives execution artifacts transmitted from the AI agent (108) or from an observability layer deployed alongside the AI agent (108). In some embodiments, the trace ingestion interface (212) receives execution artifacts in real time as the AI agent (108) processes an interaction. In other embodiments, the trace ingestion interface (212) receives execution artifacts in a batch mode after an interaction session is complete.

In some embodiments, the plurality of execution artifacts comprises at least a user input, an agent output, tool invocation metadata, and contextual metadata associated with the interaction. The user input represents the query, instruction, or message submitted by a user operating a user device (106). The agent output represents the response, action, or structured data produced by the AI agent (108) in reply to the user input. The tool invocation metadata comprises information about any tool or API calls made by the AI agent (108) during the interaction, including tool names, call parameters, response payloads, error codes, and timestamps. The contextual metadata comprises information such as retrieved documents or snippets (in retrieval-augmented generation workflows), conversation history, task domain identifiers, tenant identifiers, agent version identifiers, model version identifiers, workflow type identifiers, and channel identifiers.

The trace ingestion interface (212) operates externally to the AI agent (108) without requiring access to model weights, embeddings, or training pipelines of the AI agent (108). This external operation is a key architectural feature: the trace ingestion interface (212) consumes only the observable inputs and outputs of the AI agent (108) the execution artifacts—and does not require any instrumentation of the AI agent's internal inference process. This design enables the behavioral governance system (102) to monitor and evaluate AI agents from different model providers, of different model architectures, and of different model versions without any modification to those agents. In some embodiments, the trace ingestion interface (212) receives execution artifacts via API calls, message queues (such as Apache Kafka, RabbitMQ, or Amazon SQS), webhook notifications, or log streaming interfaces.

The segmentation engine (214) is configured to decompose the plurality of execution artifacts received by the trace ingestion interface (212) into a hierarchical structure. The hierarchical structure comprises at least one activity and a plurality of steps within the at least one activity. Each step of the plurality of steps corresponds to a discrete output or a discrete action produced by the AI agent (108) within the at least one activity. The segmentation engine (214) is communicatively coupled to the trace ingestion interface (212), receiving the execution artifacts therefrom, and is further coupled to the prompt and schema generator (216), providing the decomposed step-level execution artifacts thereto.

An activity, as used herein, represents a higher-level unit of AI agent interaction corresponding to a session or task context. For example, in a customer service deployment, an activity may correspond to a complete customer conversation session. In a task automation deployment, an activity may correspond to a complete task execution workflow. Each activity comprises one or more steps. A step represents a single discrete interaction turn within an activity—specifically, a single discrete output or discrete action produced by the AI agent (108). For example, in a multi-turn conversation, each agent response constitutes a step. In a tool-invoking workflow, each tool call and its associated agent response may constitute individual steps. The segmentation engine (214) assigns unique activity identifiers and step identifiers to each decomposed unit and preserves temporal ordering metadata including timestamps and sequence indices.

In some embodiments, the segmentation engine (214) implements rule-based decomposition logic that identifies step boundaries based on agent output boundaries (each agent response marks a new step), tool invocation boundaries (each tool call marks a new step), or configurable segmentation policies defined in the evaluation schema. In other embodiments, the segmentation engine (214) uses structural markers in the execution artifacts—such as turn delimiters, message identifiers, or API call/response pairs—to identify step boundaries. The segmentation engine (214) further associates each step with its relevant execution artifacts: the user input that prompted the step, the agent output produced in the step, any tool invocation metadata generated during the step, and the contextual metadata applicable to the step.

The prompt and schema generator (216) is configured to generate, for each step of the plurality of steps, an evaluation prompt based on step-level execution artifacts associated with the step. The evaluation prompt conforms to a predefined evaluation schema retrieved from an evaluation schema repository (114) and requires a structured output, wherein the structured output comprises a plurality of normalized evaluation signals for the step. The prompt and schema generator (216) is communicatively coupled to the segmentation engine (214), receiving the decomposed step-level execution artifacts therefrom, and to the evaluation schema repository (114), from which it retrieves the applicable evaluation schema. The prompt and schema generator (216) is further coupled to the I/O interface (206) for transmitting the generated evaluation prompt to the independent evaluator model (109).

The evaluation prompt generated by the prompt and schema generator (216) is a structured instruction that directs the independent evaluator model (109) to analyze the step-level execution artifacts and produce evaluation signals in a specific, schema-defined format. The evaluation prompt includes the step-level execution artifacts (user input, agent output, tool invocation metadata, and contextual metadata for the step) and a schema specification that mandates the format, fields, data types, and value ranges of the structured output. In some embodiments, the schema specification requires the independent evaluator model (109) to produce a JSON-conforming object containing specified fields with specified data types and value constraints. The schema specification may require each metric value to be normalized to a range of zero to one, each binary outcome indicator to be a boolean value, and each text field (such as a summary or rationale) to be a string of defined maximum length.

In some embodiments, the evaluation schema repository (114) stores a plurality of tenant-specific evaluation schemas. Each tenant-specific evaluation schema defines at least a set of metric definitions, metric data types, normalization rules, weight configurations, risk policy parameters, and confidence policy parameters specific to a tenant. The prompt and schema generator (216) retrieves a tenant-specific evaluation schema corresponding to a tenant identifier associated with the AI agent (108). This multi-tenant capability enables different organizations to configure different evaluation criteria, different quality metrics, different risk policies, and different scoring weights for their respective AI agents. In some embodiments, the evaluation schema repository (114) supports schema versioning, allowing evaluation schemas to be updated over time while preserving historical schema versions for audit and reproducibility purposes.

In some embodiments, the evaluation prompt instructs the independent evaluator model (109) to generate, for each step, at least the following categories of evaluation signals: quality metric values (such as accuracy, factuality, relevance, fluency, coherence, and reasoning quality), operational outcome indicators (such as task completion, escalation avoided, workflow correctness, actionability, and SLA adherence), risk indicator values (such as hallucination risk, compliance risk, and security and privacy risk), an evaluator confidence value, a summary text, a set of extracted keywords, and a rationale text. The quality metric values and risk indicator values are each required to be normalized to a range of zero to one. The operational outcome indicators may be boolean values or normalized values, depending on the evaluation schema configuration.

The signal validator (218) is configured to validate each structured evaluation signal record received from the independent evaluator model (109) against the predefined evaluation schema. The signal validator (218) is communicatively coupled to the I/O interface (206), from which it receives the structured evaluation signal records returned by the independent evaluator model (109), and is further coupled to the deterministic step scoring engine (220), to which it provides the validated structured evaluation signal records.

The signal validator (218) performs schema-driven validation on each structured evaluation signal record. In some embodiments, the validating comprises performing type validation, range validation, and required-field validation on the structured evaluation signal record. Type validation verifies that each field in the structured evaluation signal record conforms to the data type specified in the evaluation schema—for example, verifying that a metric value is a numeric type, not a string. Range validation verifies that each normalized metric value and risk indicator value falls within the specified range of zero to one and that other values fall within their configured acceptable ranges. Required-field validation verifies that all mandatory fields specified in the evaluation schema are present in the structured evaluation signal record. In some embodiments, the signal validator (218) further performs format validation (verifying JSON structure conformance), semantic validation (verifying that summary and rationale texts are non-empty and substantive), and consistency validation (verifying that metric values are logically consistent—for example, that a high task completion indicator is not accompanied by an extremely high hallucination risk value without supporting rationale).

Upon a validation failure, the signal validator (218) initiates a corrective action comprising at least one of a retry request to the independent evaluator model (109) and a confidence reduction for the structured evaluation signal record that failed the validation. When a retry request is initiated, the signal validator (218) re-transmits the evaluation prompt and step-level execution artifacts to the independent evaluator model (109), requesting a new structured evaluation signal record. In some embodiments, the signal validator (218) is configured to attempt a maximum of two or three retries before applying a confidence reduction. When a confidence reduction is applied, the signal validator (218) reduces the evaluator confidence value for the structured evaluation signal record that failed the validation to a value below a confidence threshold stored in the predefined evaluation schema. This reduced evaluator confidence value propagates through subsequent scoring and aggregation operations, causing the affected step to contribute less to activity-level and agent-level trust metrics. The confidence reduction mechanism ensures that unreliable evaluator model outputs do not disproportionately influence governance decisions without requiring the system to discard the evaluation signal entirely.

The deterministic step scoring engine (220) is configured to compute a step-level score for each validated step by applying a trust adjustment derived from a plurality of risk indicator values to a composite performance score. The composite performance score is derived from at least a quality score and an outcome-alignment score extracted from the structured evaluation signal record. The deterministic step scoring engine (220) is communicatively coupled to the signal validator (218), from which it receives validated structured evaluation signal records, and to the data repository (230), in which it stores the computed step-level scores.

In some embodiments, computing the step-level score comprises multiple sub-operations. First, the deterministic step scoring engine (220) calculates the quality score by applying a first set of configurable weights to the plurality of quality metric values. The quality metric values may include at least two of an accuracy metric, a factuality metric, a relevance metric, a fluency metric, a coherence metric, and a reasoning quality metric, each normalized to a range of zero to one. Each quality metric is multiplied by its corresponding weight from the first set of configurable weights, and the products are summed to produce the quality score. In some embodiments, when a quality metric is omitted from the evaluation schema for a given evaluation (for example, when fluency is not relevant to a tool-invocation step), the first set of configurable weights is renormalized to sum to one across the remaining quality metrics, ensuring that the quality score remains on a consistent scale regardless of which metrics are included.

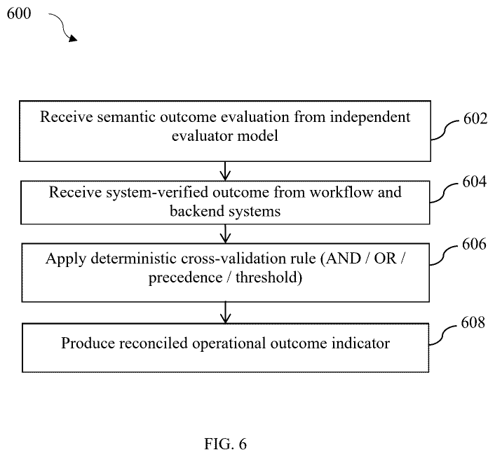

Second, the deterministic step scoring engine (220) calculates the outcome-alignment score by applying a second set of configurable weights to the plurality of operational outcome indicators. The operational outcome indicators may include task completion, escalation avoided, workflow correctness, actionability, and SLA adherence. Each operational outcome indicator is multiplied by its corresponding weight from the second set of configurable weights, and the products are summed to produce the outcome-alignment score. In some embodiments, the operational outcome indicators are derived through a hybrid confirmation process (described below with reference to the hybrid confirmation module (222) and FIG. 6) that reconciles semantic evaluations from the independent evaluator model (109) with system-verified outcomes from the workflow and backend systems (110).

Third, the deterministic step scoring engine (220) computes the composite performance score as a weighted combination of the outcome-alignment score and the quality score using a configurable weighting parameter. In some embodiments, the composite performance score is computed as P=α×O+(1−α)×Q, where P is the composite performance score, O is the outcome-alignment score, Q is the quality score, and α is the configurable weighting parameter. In some embodiments, the configurable weighting parameter α has a value between approximately 0.6 and 0.7, such that the composite performance score prioritizes operational outcome alignment over quality. This prioritization reflects the technical design choice that an AI agent which produces high-quality, but incorrect or incomplete responses provides less value in a production environment than an AI agent which reliably completes intended tasks with moderate quality.

Fourth, the deterministic step scoring engine (220) derives the trust adjustment from the plurality of risk indicator values by applying policy-defined penalty weights. The risk indicator values comprise at least a hallucination risk value, a compliance risk value, and a security and privacy risk value, each normalized to a range of zero to one. In some embodiments, the trust adjustment is computed as T=1−(w_H×H+w_C×C+w_S×S), where H is the hallucination risk value, C is the compliance risk value, S is the security and privacy risk value, w_H is a hallucination risk penalty weight, w_C is a compliance risk penalty weight, and w_S is a security risk penalty weight. In embodiments, w_C and w_S each exceed w_H. This asymmetric penalty weighting reflects the policy-driven design choice that compliance violations and security or privacy leakage carry greater organizational and regulatory consequences than hallucinated content, and therefore the system penalizes these risk categories more heavily when computing the step-level score.

Fifth, the deterministic step scoring engine (220) applies the trust adjustment to the composite performance score to produce the step-level score. In some embodiments, the step-level score is computed as the product of the composite performance score and the trust adjustment—that is, S_step=P×T. This multiplicative application means that even a high composite performance score is substantially reduced when significant compliance or security risk is detected, ensuring that operationally “successful” but risky agent behavior is appropriately penalized in the trust metric.

The deterministic step scoring engine (220) applies only deterministic, rule-based computations using configurable but fixed parameters retrieved from the evaluation schema. No non-deterministic inference, sampling, or probabilistic judgment is applied during scoring. This deterministic architecture provides audit-grade repeatability: given the same structured evaluation signal record and the same evaluation schema, the deterministic step scoring engine (220) produces the same step-level score every time, regardless of when or how many times the computation is performed.

The hybrid confirmation module (222) is configured to derive each operational outcome indicator used in the composite performance score using a combination of a semantic outcome evaluation performed by the independent evaluator model (109) and a system-verified outcome obtained from the workflow and backend systems (110). The hybrid confirmation module (222) is communicatively coupled to the I/O interface (206) for receiving system-verified outcomes from the workflow and backend systems (110) and is further coupled to the signal validator (218) for receiving the semantic outcome evaluations contained within the validated structured evaluation signal records. The hybrid confirmation module (222) provides reconciled operational outcome indicators to the deterministic step scoring engine (220).

The semantic outcome evaluation represents the independent evaluator model's assessment of whether a particular operational outcome was achieved for a given step—for example, whether the AI agent successfully resolved a customer query, whether the AI agent followed the correct procedural steps, or whether the AI agent's response was likely to satisfy the user. The system-verified outcome represents an objective, system-generated indicator derived from backend data sources—for example, a ticket status field updated in a customer relationship management system indicating resolution, an API execution result confirming a successful backend transaction, an SLA timestamp indicating that a response was delivered within the contractual time threshold, or a database state change confirming that a workflow step was completed.

The hybrid confirmation module (222) applies a deterministic cross-validation rule to reconcile the semantic outcome evaluation with the system-verified outcome to produce a reconciled operational outcome indicator for each step. In some embodiments, the deterministic cross-validation rule comprises at least one of the following: an AND-rule requiring both the semantic outcome evaluation and the system-verified outcome to indicate success for the reconciled operational outcome indicator to indicate success; an OR-rule requiring at least one of the semantic outcome evaluation and the system-verified outcome to indicate success; a precedence rule assigning priority to the system-verified outcome over the semantic outcome evaluation when the two conflict; and a threshold rule requiring the evaluator confidence value to exceed a configurable confidence threshold for the semantic outcome evaluation to contribute to the reconciled operational outcome indicator. In some embodiments, different cross-validation rules are applied to different operational outcome indicators based on the evaluation schema configuration. For example, a precedence rule may be applied to task completion (where the backend ticketing system provides authoritative resolution data), while an AND-rule may be applied to SLA adherence (where both the evaluator model's assessment and the system timestamp must agree).

The activity aggregator (224) is configured to compute an activity-level score for an activity by aggregating step-level scores across the plurality of steps within that activity. The activity aggregator (224) is communicatively coupled to the data repository (230), from which it retrieves step-level score records, and to which it stores activity score records.

The activity aggregator (224) first orders the plurality of step-level score records according to a temporal sequence corresponding to an execution order of the plurality of steps within the activity. The temporal ordering ensures that later steps—which typically depend on and build upon the context established by earlier steps—are evaluated in their correct sequential position.

The activity aggregator (224) then computes the activity-level score by applying a recency-weighted aggregation to the plurality of step-level scores. The recency-weighted aggregation assigns a higher weight to a step-level score occurring later in the temporal sequence relative to a step-level score occurring earlier in the temporal sequence. This design reflects the technical insight that in sequential, contextually dependent AI agent interactions, later steps carry greater significance because they represent the AI agent's performance on the accumulated context of all preceding steps. For example, in a customer service conversation, the final step—which typically contains the resolution or conclusion—is more consequential to the overall interaction outcome than early clarification steps.

In some embodiments, the recency-weighted aggregation uses a decay factor applied to each step-level score based on a temporal position of the corresponding step within the activity. In some embodiments, the decay factor is an exponential decay factor, and the recency-weighted aggregation computes the activity-level score as a weighted sum of the plurality of step-level scores divided by a sum of corresponding weights, wherein each weight is proportional to the exponential decay factor raised to a power determined by the temporal position of the corresponding step within the activity. In one such embodiment, the exponential decay factor γ has a default value of approximately 0.92. For an activity with K steps indexed from 1 (earliest) to K (latest), the weight for step i is γ\hat{ }(K−i), such that the latest step (i =K) has weight γ\hat{ }0=1 (the highest weight) and earlier steps have progressively smaller weights. In some embodiments, when the activity comprises a single step, the activity-level score equals the step-level score of the single step.

The activity aggregator (224) generates an activity score record comprising the activity-level score, a count of the plurality of steps, a recency weighting parameter (such as the decay factor value used), an aggregated risk indicator derived from the plurality of risk indicator values, and an aggregated evaluator confidence derived from the plurality of evaluator confidence values. In some embodiments, the aggregated evaluator confidence is computed as a weighted average of the plurality of evaluator confidence values, and the aggregated evaluator confidence is used as a signal-quality indicator for downstream time-window aggregation without modifying the activity-level score. In some embodiments, the activity aggregator (224) further generates an activity-level summary comprising aggregated keywords and a consolidated summary text derived from step-level summary texts and step-level keywords associated with the plurality of steps. The activity score record is stored in the data repository (230) linked to an agent identifier and an activity identifier.

The governance integration interface (226) is configured to transmit behavioral state outputs, trust metrics, alerts, and governance event records to the downstream governance platform (112). The governance integration interface (226) is communicatively coupled to the I/O interface (206) for outbound communication with the downstream governance platform (112). In some embodiments, the governance integration interface (226) transmits data via at least one of an application programming interface, a webhook, and a message queue. The governance integration interface (226) formats governance event records as structured data objects containing at least a tenant identifier, an agent identifier, an event type (such as ALERT, DRIFT, or STATE_CHANGE), a severity level, triggered rules, references to underlying score records, recommended actions, and a creation timestamp.

In some embodiments, the governance integration interface (226) transmits a discrete behavioral state and at least one of the activity-level score, a final window score, a drift severity value, and a behavioral indicator to the downstream governance platform (112). The discrete behavioral state is consumable by the downstream governance platform (112) to trigger at least one automated enforcement action. In some embodiments, the automated enforcement actions include downgrading tool access permissions of the AI agent (restricting the AI agent to read-only operations), requiring human-in-the-loop approval for actions of the AI agent (inserting a human review step before high-impact actions are executed), throttling a request volume directed to the AI agent (reducing concurrency limits or applying rate limiting), blocking a response of the AI agent and substituting a safe template response (intercepting responses flagged as high-risk and replacing them with predefined safe responses), and generating a structured audit record (creating a formal audit log entry documenting the behavioral state transition, the triggering conditions, and the enforcement actions taken).

The data repository (230) stores data utilized and generated by the behavioral governance system (102). In some embodiments, the data repository (230) comprises one or more databases implemented using SQL technologies (such as PostgreSQL or MySQL) or NoSQL technologies (such as MongoDB, Cassandra, or Apache HBase). The data repository (230) stores at least execution artifacts received from the AI agent (108), structured evaluation signal records received from the independent evaluator model (109), step-level scores computed by the deterministic step scoring engine (220), and activity score records generated by the activity aggregator (224). In some embodiments, the data repository (230) implements indexing structures such as B-tree indexes, hash indexes, or time-series indexes to enable efficient retrieval of score records by agent identifier, activity identifier, step identifier, timestamp, or behavioral state.

The evaluation schema repository (114) stores the predefined evaluation schemas used by the prompt and schema generator (216) and the signal validator (218). In some embodiments, the evaluation schema repository (114) is implemented as a portion of the data repository (230). In other embodiments, the evaluation schema repository (114) is implemented as a separate database or configuration store. The evaluation schema repository (114) stores metric definitions, metric data types, normalization rules, weight configurations, risk policy parameters (including the policy-defined penalty weights w_H, w_C, and w_S), confidence policy parameters (including the confidence threshold), aggregation rules (including the configurable weighting parameter α and the decay factor γ), and state-mapping rules (including the thresholds for mapping behavioral indicators to discrete behavioral states).

The score and audit data store (234) stores step-level scores, evaluator confidence values, risk indicator values, and audit trails. In some embodiments, each step-level score is stored together with an evaluator confidence value associated with the corresponding structured evaluation signal record and an audit trail linking the step-level score to the corresponding structured evaluation signal record. The audit trail enables traceability from any step-level score back to the original structured evaluation signal record from which it was derived, including the raw evaluation signals, the evaluation schema version applied, and the specific weights and parameters used in the scoring computation. This audit trail supports regulatory compliance, root-cause analysis, and dispute resolution.

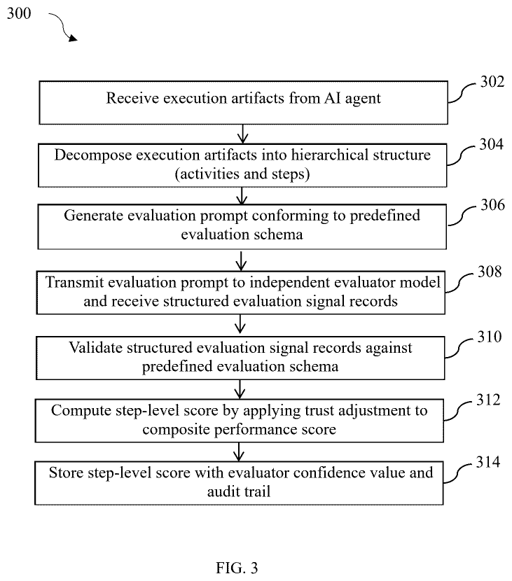

Referring now to FIG. 3, a flowchart illustrating a computer-implemented method (300) for behavioral governance of an AI agent in a production environment is shown according to one embodiment. The method (300) may be executed by the behavioral governance system (102) described with reference to FIGS. 1 and 2, specifically by the one or more processors (202) executing instructions stored in the memory (204). The method (300) corresponds to the operations recited in independent Claims 1 and 16 and their respective dependent claims.

At step (302), the method (300) comprises receiving, by the one or more processors (202), a plurality of execution artifacts generated by the AI agent (108) during an interaction. The one or more processors (202) execute the trace ingestion interface (212) to perform this receiving operation. As described above with reference to FIG. 2, the execution artifacts may comprise at least a user input, an agent output, tool invocation metadata, and contextual metadata associated with the interaction. The trace ingestion interface (212) operates externally to the AI agent (108) without requiring access to model weights, embeddings, or training pipelines of the AI agent (108). In some embodiments, the execution artifacts are received via API calls, message queues, or streaming interfaces in real time or in batch mode.

At step (304), the method (300) comprises decomposing, by the one or more processors (202), the plurality of execution artifacts into a hierarchical structure. The one or more processors (202) execute the segmentation engine (214) to perform this decomposing operation. The hierarchical structure comprises at least one activity and a plurality of steps within the at least one activity, wherein each step of the plurality of steps corresponds to a discrete output or a discrete action produced by the AI agent (108) within the at least one activity. The segmentation engine (214) assigns unique activity identifiers and step identifiers and preserves temporal ordering metadata as described above with reference to paragraphs [0021] through [0023].

At step (306), for each step of the plurality of steps, the method (300) comprises generating, by the one or more processors (202), an evaluation prompt based on step-level execution artifacts associated with the step. The one or more processors (202) execute the prompt and schema generator (216) to perform this generating operation. The evaluation prompt conforms to a predefined evaluation schema retrieved from the evaluation schema repository (114) and requires a structured output, wherein the structured output comprises a plurality of normalized evaluation signals for the step. The prompt and schema generator (216) constructs the evaluation prompt by embedding the step-level execution artifacts (user input, agent output, tool invocation metadata, and contextual metadata for the step) together with the schema specification that mandates the format, fields, data types, and value ranges of the structured output, as described above with reference to paragraphs [0024] through [0027].

At step (308), the method (300) comprises transmitting the evaluation prompt and the step-level execution artifacts to the independent evaluator model (109) distinct from the AI agent (108), and receiving, from the independent evaluator model (109), a structured evaluation signal record for the step. The one or more processors (202) execute the I/O interface (206) to transmit the evaluation prompt to the independent evaluator model (109) via the network (104) and to receive the structured evaluation signal record in response. In some embodiments, the independent evaluator model (109) is invoked via a synchronous API call, and the behavioral governance system (102) waits for the response before proceeding. In other embodiments, the invocation is asynchronous, and the behavioral governance system (102) processes other steps while awaiting the response.

At step (310), the method (300) comprises validating, by the one or more processors (202), the structured evaluation signal record against the predefined evaluation schema. The one or more processors (202) execute the signal validator (218) to perform the validation operations including type validation, range validation, and required-field validation as described above with reference to paragraphs [0028] through [0030]. Upon a validation failure, the method comprises initiating a corrective action comprising at least one of a retry request to the independent evaluator model (109) and a confidence reduction for the structured evaluation signal record that failed the validation.

At step (312), the method (300) comprises computing, by the one or more processors (202), a step-level score for the step by applying a trust adjustment derived from a plurality of risk indicator values to a composite performance score. The composite performance score is derived from at least a quality score and an outcome-alignment score extracted from the structured evaluation signal record. The one or more processors (202) execute the deterministic step scoring engine (220) to perform this computing operation. In some embodiments, the computing comprises calculating the quality score using the first set of configurable weights, calculating the outcome-alignment score using the second set of configurable weights, computing the composite performance score as a weighted combination thereof, deriving the trust adjustment using policy-defined penalty weights with asymmetric compliance and security penalties, and applying the trust adjustment to the composite performance score.

At step (314), the method (300) comprises storing, in the data repository (230), the step-level score together with an evaluator confidence value associated with the structured evaluation signal record and an audit trail linking the step-level score to the structured evaluation signal record. The one or more processors (202) write the step-level score, the evaluator confidence value, the plurality of risk indicator values, and the audit trail to the score and audit data store (234). The audit trail preserves a complete traceability chain from the step-level score back to the original structured evaluation signal record, enabling subsequent governance review, audit, and dispute resolution.

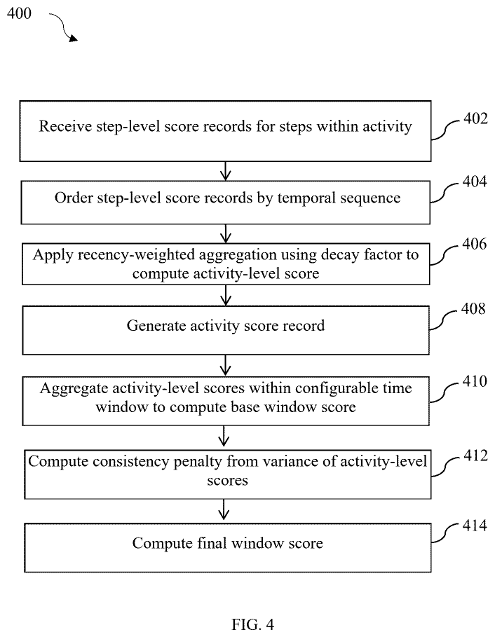

Upon completion of steps (302) through (314) for each step of the plurality of steps within an activity, the behavioral governance system (102) has produced a set of step-level scores, one per step, each accompanied by evaluator confidence values, risk indicator values, and audit trails. These step-level scores are then available for activity-level aggregation as described with reference to FIG. 4.

Referring now to FIG. 4, a flow diagram showing an activity-level and time-window aggregation process (400) is illustrated according to one embodiment. The process (400) extends the step-level evaluation described in FIG. 3 by aggregating step-level scores into activity-level trust metrics and further aggregating activity-level scores into time-windowed agent-level scores. The process (400) may be executed by the behavioral governance system (102), specifically by the activity aggregator (224) and associated time-window aggregation logic.

At step (402), the process (400) comprises receiving a plurality of step-level score records for a plurality of steps within an activity of the AI agent (108). Each step-level score record comprises a step-level score, an evaluator confidence value, and a plurality of risk indicator values. The step-level score has been computed by applying a trust adjustment derived from the plurality of risk indicator values to a composite performance score, the composite performance score being derived from at least a quality score and an outcome-alignment score, as described with reference to FIG. 3. The step-level score records are retrieved from the data repository (230).

At step (404), the process (400) comprises ordering the plurality of step-level score records according to a temporal sequence corresponding to an execution order of the plurality of steps within the activity. The ordering is based on the timestamps and sequence indices assigned by the segmentation engine (214) during decomposition. This temporal ordering is essential for the recency-weighted aggregation performed in the next step, as the weight assigned to each step-level score depends on the temporal position of the corresponding step within the activity.

At step (406), the process (400) comprises computing, by the activity aggregator (224), an activity-level score for the activity by applying a recency-weighted aggregation to the plurality of step-level scores. The recency-weighted aggregation assigns a higher weight to a step-level score occurring later in the temporal sequence relative to a step-level score occurring earlier in the temporal sequence. In some embodiments, the recency-weighted aggregation uses an exponential decay factor γ applied to each step-level score based on the temporal position of the corresponding step. For an activity with K steps indexed from 1 (earliest) to K (latest), the activity-level score A is computed as:

$$A = Σ ( i = 1 to K ) [ γ \hat{} ( K - i ) \times S\_i ] / Σ ( i = 1 to K ) [ γ \hat{} ( K - i ) ]$$

where S_i is the step-level score for step i and γ is the exponential decay factor. In some embodiments, γ has a default value of approximately 0.92. When the activity comprises a single step (K =1), the activity-level score equals the step-level score of the single step.

At step (408), the process (400) comprises generating an activity score record comprising the activity-level score, a count of the plurality of steps, a recency weighting parameter (the value of the decay factor used), an aggregated risk indicator derived from the plurality of risk indicator values, and an aggregated evaluator confidence derived from the plurality of evaluator confidence values. In some embodiments, the aggregated evaluator confidence is computed as a weighted average of the plurality of evaluator confidence values. The aggregated evaluator confidence is used as a signal-quality indicator for downstream time-window aggregation without modifying the activity-level score. The activity score record is stored in the data repository (230) linked to an agent identifier and an activity identifier.

At step (410), the process (400) comprises aggregating a plurality of activity-level scores within a configurable time window to compute a base window score for the AI agent (108). In some embodiments, the configurable time window is one of hourly, daily, weekly, or monthly. The base window score may be computed as a confidence-weighted average of the activity-level scores within the time window, where the aggregated evaluator confidence of each activity serves as the weight. In other embodiments, the base window score is a simple arithmetic mean of the activity-level scores within the time window. In some embodiments, the base window score may additionally weight each activity-level score by the step count of the corresponding activity, giving higher influence on activities with more steps (and therefore more evaluation data points).

At step (412), the process (400) comprises computing a consistency penalty based on a variance of the plurality of activity-level scores within the configurable time window. The consistency penalty quantifies the degree to which the AI agent's performance varied across activities within the time window. A high variance indicates inconsistent performance across interactions, which is itself a governance concern even if the average score is acceptable. In some embodiments, the consistency penalty is computed as κ×σ, where σ is the standard deviation of the activity-level scores within the time window and κ is a consistency penalty coefficient. In some embodiments, the consistency penalty coefficient varies by window type: κ_hourly is approximately 0.15, κ_daily is approximately 0.25, and κ_weekly is approximately 0.30, reflecting the principle that longer time windows should penalize inconsistency more heavily because consistent performance over longer periods is more important for governance stability.

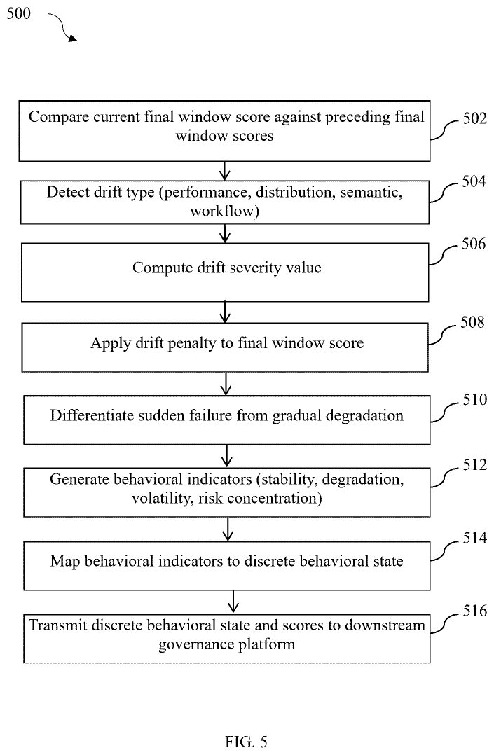

At step (414), the process (400) comprises computing a final window score by subtracting the consistency penalty from the base window score. In some embodiments, the final window score is further adjusted by a drift penalty as described with reference to FIG. 5.

Referring now to FIG. 5, a flowchart depicting a drift detection and behavioral state generation process (500) is illustrated according to one embodiment. The process (500) extends the time-window aggregation described in FIG. 4 by detecting behavioral drift across time windows, differentiating types and severities of drift, generating behavioral indicators, and mapping those indicators to discrete behavioral states suitable for automated governance enforcement.

At step (502), the process (500) comprises detecting a behavioral drift by comparing the final window score of a current time window against a final window score of at least one preceding time window of a same window type using a deterministic comparison rule. For example, the final daily window score for today is compared against the final daily window scores for the preceding seven days. The deterministic comparison rule may compute a difference, a ratio, or a regression slope across the compared window scores to determine whether a statistically meaningful change has occurred.

At step (504), the process (500) comprises detecting the type of behavioral drift. In some embodiments, detecting the behavioral drift comprises detecting at least one of: a performance drift based on a change in a mean or a variance of window scores across consecutive time windows; a distribution drift based on a change in a score distribution across the consecutive time windows; a semantic drift based on a change in at least one of extracted topics, extracted keywords, or reasoning patterns derived using predefined deterministic transformation rules; and a workflow drift based on a change in at least one of task type distributions, tool failure rates, or escalation rates. Performance drift captures overall score trends. Distribution drift captures changes in the shape of the score distribution even when the mean remains stable —for example, a bimodal distribution replacing a unimodal distribution may indicate that the AI agent is performing well on some interaction types while performing poorly on others. Semantic drift captures changes in the content characteristics of the AI agent's outputs. Workflow drift captures changes in operational patterns such as increased tool failures or escalation rates.

In some embodiments, semantic drift is detected deterministically by applying predefined transformation rules to step-level keywords, topics, and summary texts. For example, the system may compute keyword overlap ratios between the current time window and preceding time windows, detect the emergence of new topics do not present in preceding windows, or apply embedding-based similarity thresholds to summary texts using precomputed reference embeddings. These transformations are deterministic in that they apply fixed rules (thresholds, ratios, set operations) to structured data extracted by the independent evaluator model (109)—the system does not invoke an additional LLM for drift detection.

At step (506), the process (500) comprises computing a drift severity value in a range of zero to one. The drift severity value represents a composite measure of the magnitude and breadth of detected drift. In some embodiments, the drift severity value is computed as a weighted combination of drift indicators across the drift types detected at step (504). Higher drift severity values indicate more significant behavioral change.

At step (508), the process (500) comprises applying a drift penalty derived from the drift severity value to the final window score. In some embodiments, the drift penalty is computed as δ×D_W, where D_W is the drift severity value and δ is a drift penalty coefficient. In some embodiments, the drift penalty coefficient varies by window type: δ_hourly is approximately 0.25, δ_daily is approximately 0.35, and δ_weekly is approximately 0.40. The adjusted final window score is computed by subtracting the drift penalty from the final window score computed at step (414) of FIG. 4.

At step (510), the process (500) comprises differentiating a sudden failure from a gradual degradation by analyzing a combination of a score variance measure and a trend slope computed over a configurable number of consecutive time windows. In some embodiments, a sudden failure is identified when the score variance exceeds a variance threshold within a single time window and the trend slope does not indicate a preceding decline—that is, performance was stable or improving in preceding windows and then dropped abruptly. A gradual degradation is identified when the trend slope exceeds a negative slope threshold over the configurable number of consecutive time windows—that is, performance has been declining consistently over multiple windows. This differentiation is important for governance because sudden failures and gradual degradations typically require different enforcement responses: a sudden failure may indicate a model change, a data pipeline error, or a prompt modification that requires immediate investigation, while a gradual degradation may indicate distribution shift, data drift, or model staleness that requires monitoring and planned intervention.

At step (512), the process (500) comprises generating at least one behavioral indicator selected from a group consisting of a stability indicator, a degradation indicator, a volatility indicator, and a risk concentration indicator. Each behavioral indicator is computed deterministically from at least one of temporal score patterns, variance measures, and risk signal distributions. The stability indicator quantifies the consistency and acceptable-range adherence of the AI agent's performance over time. The degradation indicator quantifies the magnitude and duration of any declining performance trend. The volatility indicator quantifies the variance and unpredictability of performance across activities and time windows. The risk concentration indicator quantifies whether risk signals are concentrated in particular categories (for example, disproportionately high compliance risk relative to other risk types) or across particular interaction types.

At step (514), the process (500) comprises mapping the at least one behavioral indicator to a discrete behavioral state selected from a group consisting of STABLE, DEGRADING, UNSTABLE, HIGH_RISK, and LOW_CONFIDENCE, using deterministic threshold-based mapping rules. In some embodiments, the mapping rules are defined in the evaluation schema and comprise threshold conditions for each behavioral state. For example: the STABLE state is assigned when the stability indicator exceeds a stability threshold, the degradation indicator is below a degradation threshold, and the risk concentration indicator is below a risk threshold; the DEGRADING state is assigned when the degradation indicator exceeds the degradation threshold over a configurable number of consecutive time windows; the UNSTABLE state is assigned when the volatility indicator exceeds a volatility threshold; the HIGH_RISK state is assigned when the risk concentration indicator exceeds a high-risk threshold; and the LOW_CONFIDENCE state is assigned when the aggregated evaluator confidence remains below the confidence threshold over a sustained number of time windows. The discrete behavioral states are machine-interpretable labels that can be consumed programmatically by downstream systems without human interpretation.

At step (516), the process (500) comprises transmitting, by the governance integration interface (226), the discrete behavioral state and at least one of the activity-level score, the final window score, the drift severity value, and the at least one behavioral indicator to the downstream governance platform (112) via at least one of an application programming interface, a webhook, and a message queue.

In some embodiments, the behavioral governance system (102) persists each final window score, together with the corresponding base window score, consistency penalty, drift severity value, drift penalty, behavioral indicators, and discrete behavioral state, as a time-series record in the data repository (230). Each time-series record is associated with an agent identifier, a window type identifier (hourly, daily, weekly, or monthly), and a window start and end timestamp. The data repository (230) stores these time-series records chronologically, enabling the behavioral governance system (102) to retrieve and compare window scores across successive time windows for the same agent and window type. In some embodiments, the data repository (230) implements a time-series database or a time-series indexed table optimized for range queries over temporal data, enabling efficient retrieval of window scores over configurable lookback periods (for example, the preceding thirty daily windows or the preceding twelve weekly windows). The time-series storage enables the drift detection operations by providing the historical baseline against which current window scores are compared at step (502).

In some embodiments, the behavioral governance system (102) maintains historical agent-level performance trends across multiple dimensions of evaluation for a plurality of AI agents operating across heterogeneous models or vendors. Each AI agent is identified by a unique agent identifier, and the time-series records for each agent are stored independently in the data repository (230). The behavioral governance system (102) enables cross-agent comparison by normalizing window scores across agents using a common evaluation schema or by applying agent-specific normalization baselines derived from each agent's historical performance distribution. In some embodiments, the system distinguishes normal behavioral variability from statistically meaningful drift by computing baseline statistics (such as a rolling mean and rolling standard deviation) for each agent over a configurable historical lookback period, and by flagging drift only when current window scores deviate from the baseline by more than a configurable number of standard deviations. This historical baseline approach enables the system to account for inherent performance differences between AI agents from different model providers or of different model architectures without generating false drift signals.

In some embodiments, the drift detection operations described in FIG. 5 operate independently of infrastructure performance metrics such as latency, token usage, uptime, error rates, or request throughput. The behavioral governance system (102) does not ingest or analyze infrastructure telemetry from the AI agent (108). Instead, drift detection is based entirely on outcome-level and risk-level signals derived from the step-level scores, activity-level scores, and the behavioral indicators described herein. This independence from infrastructure metrics is a deliberate architectural choice: an AI agent may exhibit stable infrastructure telemetry while silently degrading in outcome quality, increasing risk exposure, or shifting semantic behavior. By monitoring behavioral signals rather than infrastructure signals, the behavioral governance system (102) detects a class of AI agent failures —silent behavioral degradation—that is invisible to conventional observability and monitoring systems.

In some embodiments, the behavioral governance system (102) comprises an alerting and notification engine (which may be implemented as a component of the governance integration interface (226) or as a separate module) that evaluates configurable threshold conditions against aggregated agent scores, drift indicators, and behavioral states, and that triggers automated alerts when threshold conditions are breached. In some embodiments, the alerting and notification engine evaluates threshold conditions including: a final window score falling below a minimum score threshold; a drift severity value exceeding a maximum drift threshold; a discrete behavioral state transitioning from STABLE to any non-STABLE state; or a specific risk indicator value exceeding a risk alert threshold. The alerting and notification engine generates structured alert records comprising a tenant identifier, an agent identifier, an alert type, a severity level, the triggered threshold condition, a reference to the underlying window score or behavioral state record, and a timestamp. Alerts are transmitted to the downstream governance platform (112) and, in some embodiments, are additionally transmitted via email, messaging platforms (such as Slack, Microsoft Teams, or PagerDuty), or notification APIs. The alerting and notification engine operates without requiring manual inspection of logs, transcripts, or raw agent outputs—alerts are generated automatically based on deterministic threshold evaluation against the computed behavioral signals. In some embodiments, the threshold conditions are defined per tenant in the evaluation schema, enabling different organizations to configure different alert sensitivity levels for their respective AI agents. In some embodiments, the incorporation of evaluator confidence into the time-window aggregation (as described in paragraph [0065]) reduces false alert signals caused by ambiguous or low-certainty evaluations, because lower-confidence activities contribute less weight to the window score and therefore are less likely to cause the window score to breach alert thresholds.

In some embodiments, each behavioral indicator is computed from a combination of temporal score patterns, variance measures, risk signal distributions, and confidence-weighted contributions. The confidence-weighted contributions incorporate the aggregated evaluator confidence values from the activity score records, such that time windows with lower overall evaluator confidence contribute less influence on behavioral indicator computations. In some embodiments, the behavioral indicators are computed as follows. The stability indicator is computed as a function of the proportion of time windows within a lookback period in which the final window score exceeds a minimum acceptable score threshold and the score variance is below a maximum variance threshold—for example, the stability indicator may be set to the ratio of stable windows to total windows in the lookback period. The degradation indicator is computed as a function of the trend slope of the final window scores over a configurable number of consecutive time windows—for example, the degradation indicator may be set to the absolute value of a negative slope computed using linear regression over the window scores, normalized to the range of zero to one. The volatility indicator is computed as a function of the standard deviation or coefficient of variation of the final window scores within a lookback period—for example, the volatility indicator may be set to the coefficient of variation normalized to the range of zero to one using a configurable maximum volatility threshold. The risk concentration indicator is computed as a function of the distribution of risk indicator values across risk categories (hallucination, compliance, security/privacy)—for example, the risk concentration indicator may be set to the maximum of the category-level risk averages divided by the overall risk average, measuring whether risk is disproportionately concentrated in a single category. These computation examples are illustrative; other computation approaches are within the scope of the invention provided that the computation is deterministic and rule based.

Referring now to FIG. 6, a flow diagram illustrating a hybrid confirmation process (600) for reconciling semantic and system-verified operational outcome indicators is shown

### According to One Embodiment.

At step (602), the hybrid confirmation process (600) comprises receiving a semantic outcome evaluation from the independent evaluator model (109). The semantic outcome evaluation is a component of the structured evaluation signal record and represents the independent evaluator model's assessment of whether a particular operational outcome was achieved for a given step. For example, the semantic outcome evaluation may indicate whether the AI agent successfully resolved a customer query based on the natural language content of the agent output and the context of the interaction.

At step (604), the hybrid confirmation process (600) comprises receiving a system-verified outcome from the workflow and backend systems (110). The system-verified outcome represents an objective indicator derived from backend data sources. In some embodiments, the system-verified outcome is obtained from at least one of a workflow state log, a ticketing system update, a backend database state change, and an application programming interface execution result. For example, the system-verified outcome may indicate that a support ticket was marked as “resolved” in the ticketing system, that a database record was updated confirming order fulfillment, or that an API call to a downstream service returned a success response code.

At step (606), the hybrid confirmation process (600) comprises applying a deterministic cross-validation rule to reconcile the semantic outcome evaluation with the system-verified outcome. As described above, the deterministic cross-validation rule may comprise an AND-rule, an OR-rule, a precedence rule, or a threshold rule, depending on the evaluation schema configuration for the specific operational outcome indicator.

At step (608), the hybrid confirmation process (600) comprises producing a reconciled operational outcome indicator for each step of the plurality of steps. The reconciled operational outcome indicator integrates both the semantic assessment (what the evaluator model believes happened) and the system-verified evidence (what the backend systems confirm happened), producing a more reliable outcome signal than either source alone. The reconciled operational outcome indicator is provided to the deterministic step scoring engine (220) for use in computing the outcome-alignment score.

The behavioral governance system (102) supports multiple normalization approaches for converting raw metric values and raw operational data into normalized values suitable for scoring. In some embodiments, the normalization approach is selected on a per-metric basis based on the metric type specified in the evaluation schema. The supported normalization approaches include at least the following.

Boolean normalization maps a value to zero or one. This approach is used for binary indicators such as whether a task was completed (1) or not (0), or whether an escalation was avoided (1) or occurred (0).

Min-max normalization clips a raw value to a configured range defined by a minimum value and a maximum value and then maps the clipped value to the range of zero to one using the formula: normalized=(value−min)/(max−min). In some embodiments, the configured range is defined per metric in the evaluation schema.

Good-threshold normalization maps values at or below a good threshold to a higher normalized score for lower-is-better metrics. This approach is used for metrics such as response time or error count, where lower values indicate better performance. In some embodiments, values at or below the good threshold are mapped to 1.0, and values above the good threshold are mapped to progressively lower normalized scores based on a configurable decay curve.

Rate normalization computes a ratio of a count of successful events to a total count of events—for example, the ratio of resolved activities to total activities, or the ratio of successful tool invocations to total tool invocations. The resulting ratio inherently falls within the range of zero to one.

Target-based normalization maps a raw value to a normalized score based on a minimum value, a maximum value, a target value, and a direction indicator (higher-is-better or lower-is-better). In some embodiments, for higher-is-better metrics, values at or above the target value are mapped to 1.0, values at or below the minimum value are mapped to 0.0, and intermediate values are mapped linearly. For lower-is-better metrics, the mapping is inverted.

While the embodiments described above illustrate specific implementations, the invention may be practiced with various modifications and alternative configurations without departing from the scope of the claims.

In some embodiments, the discrete behavioral states may be extended beyond the five states described herein (STABLE, DEGRADING, UNSTABLE, HIGH_RISK, and LOW_CONFIDENCE) to include additional states such as RECOVERING (indicating an improving trend following a period of degradation), QUARANTINED (indicating that the AI agent has been isolated from production traffic), or UNDER_REVIEW (indicating that human governance review is in progress). These and other variations are within the scope of the invention as defined by the appended claims.

The present disclosure provides significant technical advancements in the field of AI agent monitoring and governance computing systems. The disclosed systems and methods address technical limitations of existing approaches and provide concrete improvements to computer functionality that go beyond routine application of known techniques.

First, the disclosed architecture improves computational determinism in AI agent evaluation by constraining a non-deterministic evaluator model output through schema-enforced structured signal extraction, schema-based validation with automated retry and confidence reduction corrective actions, and deterministic rule-based scoring. The independent evaluator model (109)—being a large language model—is inherently non-deterministic: the same prompt may produce different outputs on different invocations. However, by constraining the evaluator model's output to conform to a predefined evaluation schema (requiring specific fields, specific data types, specific value ranges), by validating the output against the schema and applying corrective actions (retries and confidence reduction) upon validation failure, and by applying only deterministic, rule-based computations to the validated signals, the behavioral governance system (102) transforms variable evaluator model outputs into repeatable, audit-grade step-level scores. This is an unconventional use of a language model: rather than relying on the language model's judgment as the final output, the system uses the language model as a constrained signal extractor whose output is subjected to validation and deterministic processing.

Second, processing efficiency is enhanced through hierarchical decomposition of execution artifacts into discrete steps that are independently scored and selectively aggregated. Rather than evaluating an entire interaction session as a monolithic unit —which requires loading the full interaction context into the evaluator model and produces a single coarse-grained score—the system decomposes the interaction into discrete steps, evaluates each step independently with only the step-relevant context, and aggregates the step-level scores using deterministic rules. This hierarchical approach reduces the per-evaluation context size (improving evaluator model throughput), enables parallel evaluation of independent steps, and allows selective re-evaluation of individual steps without re-processing the entire interaction.

Third, the trust adjustment mechanism provides an unconventional risk-penalization approach that applies asymmetric policy-defined penalty weights. Unlike conventional scoring systems that apply uniform penalty weights to all risk categories or that treat risk as a single aggregate dimension, the disclosed system separates risk into distinct categories (hallucination, compliance, security/privacy) and applies different penalty weights to each category based on configurable policies. In embodiments where the compliance risk penalty weight and the security risk penalty weight each exceed the hallucination risk penalty weight, the system encodes a policy-driven governance logic: an AI agent that hallucinates but does not violate compliance or security policies is penalized less severely than an AI agent that produces accurate content but leaks sensitive data or deviates from regulatory requirements. This asymmetric penalization is not achievable through conventional uniform risk weighting and provides risk-aware step-level scores that reflect policy-driven behavioral accountability.

Fourth, the recency-weighted activity-level aggregation using a configurable decay factor provides a temporally sensitive trust metric that assigns greater influence on later steps within an activity, capturing the cumulative contextual dependency of sequential AI agent interactions more accurately than uniform averaging. In multi-turn AI agent interactions, later steps depend on and build upon the context established by earlier steps. An AI agent that performs well on initial steps but fails on the final resolution step has, from a governance perspective, delivered an unsuccessful outcome. Conversely, an AI agent that stumbles on early clarification steps but successfully resolves the task in the final step has delivered a successful outcome. Uniform averaging would obscure this distinction. The recency-weighted aggregation with exponential decay accurately captures this temporal dependency structure.

Fifth, the drift detection and behavioral state generation capabilities (described with reference to FIG. 5) enable the detection of a class of AI agent failures that are invisible to conventional observability systems. An AI agent may exhibit stable infrastructure telemetry (latency, token usage, uptime) while gradually degrading in outcome quality, increasing risk exposure, or shifting semantic behavior. The disclosed system detects these silent behavioral degradations by monitoring outcome-level and risk-level trends over configurable time windows, differentiating sudden failures from gradual degradation, and generating discrete, machine-interpretable behavioral states that downstream governance platforms can consume to trigger automated enforcement actions. This capability fills a technical gap between infrastructure monitoring and behavioral governance that existing systems do not address.

Sixth, the hybrid confirmation module (222) provides a cross-validation mechanism that reconciles two fundamentally different signal sources—semantic evaluations from a language model and objective system-verified outcomes from backend systems—using deterministic cross-validation rules. This hybrid approach produces more reliable operational outcome indicators than either source alone. The semantic evaluation captures nuanced quality assessments that system logs cannot provide (such as whether a response was helpful, clear, and contextually appropriate), while the system-verified outcome provides objective evidence that the language model's assessment cannot fabricate (such as whether a ticket was actually resolved, whether an API call actually succeeded, or whether a response was actually delivered within the SLA threshold).

The foregoing description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

While specific embodiments have been illustrated and described, it will be appreciated that various changes can be made without departing from the scope of the invention. For example, the order of certain processing steps may be altered, components may be substituted with functional equivalents, the system may be scaled up or down depending on application requirements, and the specific algorithms, data structures, and parameters described herein may be varied while maintaining the inventive concept of deterministic, risk-aware behavioral governance of AI agents using schema-constrained evaluation signal extraction, policy-driven trust adjustment, and recency-weighted temporal aggregation.

The scope of the invention is indicated by the appended claims rather than by the foregoing description. All changes which come within the meaning and range of equivalency of the claims are to be embraced within their scope.

We claim:

1. A system for governance of an artificial intelligence (AI) agent comprising:
one or more processors; and
a memory coupled to the one or more processors and storing instructions executable by the one or more processors to perform operations comprising:
receiving, a plurality of execution artifacts generated by the AI agent during an interaction;
decomposing, the plurality of execution artifacts into a hierarchical structure, wherein the hierarchical structure comprises at least one activity and a plurality of steps within the at least one activity, wherein each step of the plurality of steps corresponds to a discrete output or a discrete action produced by the AI agent within the at least one activity;
for each step, generating, an evaluation prompt based on step-level execution artifacts associated with the step, the evaluation prompt conforming to a predefined evaluation schema retrieved from an evaluation schema repository and requiring a structured output, wherein the structured output comprises a plurality of normalized evaluation signals for the step;
transmitting the evaluation prompt and the step-level execution artifacts to an independent evaluator model distinct from the AI agent, and receiving, from the independent evaluator model, a structured evaluation signal record for the step;
validating, the structured evaluation signal record against the predefined evaluation schema, and upon a validation failure, initiating a corrective action comprising at least one of a retry request to the independent evaluator model and a confidence reduction for the structured evaluation signal record that failed the validation;
computing, a step-level score for the step by applying a trust adjustment derived from a plurality of risk indicator values to a composite performance score, the composite performance score being derived from at least a quality score and an outcome-alignment score extracted from the structured evaluation signal record; and
storing, in a data repository, the step-level score together with an evaluator confidence value associated with the structured evaluation signal record and an audit trail linking the step-level score to the structured evaluation signal record.

2. The system of claim 1, wherein the plurality of execution artifacts comprises at least a user input, an agent output, tool invocation metadata, and contextual metadata associated with the interaction, and wherein the trace ingestion interface operates externally to the AI agent without requiring access to model weights, embeddings, or training pipelines of the AI agent.

3. The system of claim 1, wherein the structured evaluation signal record comprises a plurality of quality metric values, a plurality of operational outcome indicators, a plurality of risk indicator values each normalized to a range of zero to one, and the evaluator confidence value.

4. The system of claim 3, wherein the validating comprises performing type validation, range validation, and required-field validation on the structured evaluation signal record, and wherein the confidence reduction reduces the evaluator confidence value for the structured evaluation signal record that failed the validation to a value below a confidence threshold stored in the predefined evaluation schema.

5. The system of claim 3, wherein the computing the step-level score comprises:
calculating the quality score by applying a first set of configurable weights to the plurality of quality metric values;
calculating the outcome-alignment score by applying a second set of configurable weights to the plurality of operational outcome indicators;
computing the composite performance score as a weighted combination of the outcome-alignment score and the quality score using a configurable weighting parameter; and
deriving the trust adjustment from the plurality of risk indicator values by applying policy-defined penalty weights, wherein a compliance risk penalty weight and a security and privacy risk penalty weight each exceed a hallucination risk penalty weight.

6. The system of claim 5, wherein the trust adjustment is computed as:
T=1−(w_H×H+w_C×C+w_S×S), wherein H is a hallucination risk value, C is a compliance risk value, S is a security and privacy risk value, w_H is a hallucination risk penalty weight, w_C is a compliance risk penalty weight, and w_S is a security and privacy risk penalty weight, and wherein w_C and w_S each exceed w_H, and wherein the step-level score is a product of the composite performance score and the trust adjustment.

7. The system of claim 3, wherein the operations further comprise: deriving, by a hybrid confirmation module, each operational outcome indicator used in the composite performance score using a combination of a semantic outcome evaluation performed by the independent evaluator model, and a system-verified outcome obtained from at least one of a workflow state log, a ticketing system update, a backend database state change, and an application programming interface execution result, wherein the hybrid confirmation module applies a deterministic cross-validation rule to reconcile the semantic outcome evaluation with the system-verified outcome to produce a reconciled operational outcome indicator for each step of the plurality of steps.

8. The system of claim 7, wherein the deterministic cross-validation rule comprises at least one of an AND-rule requiring both the semantic outcome evaluation and the system-verified outcome to indicate success for the reconciled operational outcome indicator to indicate success, an OR-rule requiring at least one of the semantic outcome evaluation and the system-verified outcome to indicate success, a precedence rule assigning priority to the system-verified outcome over the semantic outcome evaluation when the semantic outcome evaluation and the system-verified outcome conflict, and a threshold rule requiring the evaluator confidence value to exceed a configurable confidence threshold for the semantic outcome evaluation to contribute to the reconciled operational outcome indicator.

9. The system of claim 1, wherein the evaluation schema repository stores a plurality of tenant-specific evaluation schemas, each tenant-specific evaluation schema defining at least a set of metric definitions, metric data types, normalization rules, weight configurations, risk policy parameters, and confidence policy parameters specific to a tenant, and wherein the prompt and schema generator retrieves a tenant-specific evaluation schema corresponding to a tenant identifier associated with the AI agent.

10. The system of claim 1, wherein the structured evaluation signal record further comprises a summary text, a set of extracted keywords, and a rationale text generated by the independent evaluator model for the corresponding step, and wherein the summary text, the set of extracted keywords, and the rationale text are stored in the data repository as structured fields linked to the step-level score.

11. A system for generating risk-adjusted activity-level trust metrics for an AI agent, the system comprising:
one or more processors; and
a memory coupled to the one or more processors and storing instructions executable by the one or more processors to perform operations comprising:
receiving a plurality of step-level score records for a plurality of steps within an activity of the AI agent, each step-level score record comprising a step-level score, an evaluator confidence value, and a plurality of risk indicator values, the step-level score having been computed by applying a trust adjustment derived from the plurality of risk indicator values to a composite performance score, the composite performance score being derived from at least a quality score and an outcome-alignment score;
ordering the plurality of step-level score records according to a temporal sequence corresponding to an execution order of the plurality of steps within the activity;
computing, by an activity aggregator, an activity-level score for the activity by applying a recency-weighted aggregation to the plurality of step-level scores, the recency-weighted aggregation assigning a higher weight to a step-level score occurring later in the temporal sequence relative to a step-level score occurring earlier in the temporal sequence, wherein the recency-weighted aggregation uses a decay factor applied to each step-level score based on a temporal position of the corresponding step within the activity;
generating an activity score record comprising the activity-level score, a count of the plurality of steps, a recency weighting parameter, an aggregated risk indicator derived from the plurality of risk indicator values, and an aggregated evaluator confidence derived from evaluator confidence values associated with the plurality of step-level score records; and
storing the activity score record in a data repository linked to an agent identifier and an activity identifier.

12. The system of claim 11, wherein the decay factor is an exponential decay factor, and wherein the recency-weighted aggregation computes the activity-level score as a weighted sum of the plurality of step-level scores divided by a sum of corresponding weights, wherein each weight is proportional to the exponential decay factor raised to a power determined by the temporal position of the corresponding step within the activity.

13. The system of claim 11, wherein when the activity comprises a single step, the activity-level score equals the step-level score of the single step.

14. The system of claim 11, wherein the operations further comprise generating an activity-level summary comprising aggregated keywords and a consolidated summary text derived from step-level summary texts and step-level keywords associated with the plurality of steps.

15. The system of claim 11, wherein the aggregated evaluator confidence is computed as a weighted average of the plurality of evaluator confidence values, and wherein the aggregated evaluator confidence is used as a signal-quality indicator for downstream time-window aggregation without modifying the activity-level score.

16. A method for governance of an artificial intelligence (AI) agent, wherein the method comprising steps of:
receiving, by one or more processors, a plurality of execution artifacts generated by the AI agent during an interaction;
decomposing, by the one or more processors, the plurality of execution artifacts into a hierarchical structure, wherein the hierarchical structure comprises at least one activity and a plurality of steps within the at least one activity, wherein each step of the plurality of steps corresponds to a discrete output or a discrete action produced by the AI agent within the at least one activity;
generating, by the one or more processors, an evaluation prompt based on step-level execution artifacts associated with the step, the evaluation prompt conforming to a predefined evaluation schema retrieved from an evaluation schema repository and requiring a structured output comprising a plurality of normalized evaluation signals for the step;
transmitting the evaluation prompt and the step-level execution artifacts to an independent evaluator model distinct from the AI agent, and receiving, from the independent evaluator model, a structured evaluation signal record for the step;
validating, by the one or more processors, the structured evaluation signal record against the predefined evaluation schema, and upon a validation failure, initiating a corrective action comprising at least one of a retry request to the independent evaluator model and a confidence reduction for the structured evaluation signal record that failed the validation;
computing, by the one or more processors, a step-level score for the step by applying a trust adjustment derived from a plurality of risk indicator values to a composite performance score, the composite performance score being derived from at least a quality score and an outcome-alignment score extracted from the structured evaluation signal record; and
storing, in a data repository, the step-level score together with an evaluator confidence value associated with the structured evaluation signal record and an audit trail linking the step-level score to the structured evaluation signal record.

17. The method of claim 16, wherein the plurality of execution artifacts comprise at least a user input, an agent output, tool invocation metadata, and contextual metadata associated with the interaction, and wherein the receiving operates externally to the AI agent without requiring access to model weights, embeddings, or training pipelines of the AI agent.

18. The method of claim 16, wherein the structured evaluation signal record comprises a plurality of quality metric values, a plurality of operational outcome indicators, a plurality of risk indicator values each normalized to a range of zero to one, and the evaluator confidence value, and wherein the computing the step-level score comprises:
calculating the quality score by applying a first set of configurable weights to the plurality of quality metric values;
calculating the outcome-alignment score by applying a second set of configurable weights to the plurality of operational outcome indicators;
computing the composite performance score as a weighted combination of the outcome-alignment score and the quality score using a configurable weighting parameter; and
deriving the trust adjustment from the plurality of risk indicator values by applying policy-defined penalty weights, wherein at least one of a compliance risk penalty weight and a security and privacy risk penalty weight exceeds a hallucination risk penalty weight.

19. The method of claim 18, further comprising:
deriving each operational outcome indicator using a combination of:
a semantic outcome evaluation performed by the independent evaluator model, and
a system-verified outcome obtained from at least one of a workflow state log, a ticketing system update, a backend database state change, and an application programming interface execution result,
wherein the deriving applies a deterministic cross-validation rule to reconcile the semantic outcome evaluation with the system-verified outcome.

20. The method of claim 16, further comprising:
ordering the step-level scores for the plurality of steps within the at least one activity according to a temporal sequence corresponding to an execution order of the plurality of steps; and
computing an activity-level score by applying a recency-weighted aggregation to the step-level scores, the recency-weighted aggregation assigning a higher weight to a step-level score occurring later in the temporal sequence using an exponential decay factor.

21. The method of claim 20, further comprising:
aggregating a plurality of activity-level scores within a configurable time window to compute a base window score for the AI agent;
computing a consistency penalty based on a variance of the plurality of activity-level scores within the configurable time window; and
computing a final window score by subtracting the consistency penalty from the base window score.

22. The method of claim 21, further comprising:
detecting a behavioral drift by comparing the final window score of a current time window against a final window score of at least one preceding time window of a same window type using a deterministic comparison rule;
computing a drift severity value in a range of zero to one; and
applying a drift penalty derived from the drift severity value to the final window score.

23. The method of claim 22, wherein the detecting the behavioral drift comprises detecting at least one of: a performance drift based on a change in a mean or a variance of window scores across consecutive time windows, a distribution drift based on a change in a score distribution across the consecutive time windows, a semantic drift based on a change in at least one of extracted topics, extracted keywords, or reasoning patterns derived using predefined deterministic transformation rules, and a workflow drift based on a change in at least one of task type distributions, tool failure rates, or escalation rates.

24. The method of claim 22, further comprising differentiating a sudden failure from a gradual degradation by analyzing a combination of a score variance measure and a trend slope computed over a configurable number of consecutive time windows, wherein a sudden failure is identified when the score variance exceeds a variance threshold within a single time window and the trend slope does not indicate a preceding decline, and a gradual degradation is identified when the trend slope exceeds a negative slope threshold over the configurable number of the consecutive time windows.

25. The method of claim 22, further comprising
generating at least one behavioral indicator selected from a group consisting of a stability indicator, a degradation indicator, a volatility indicator, and a risk concentration indicator, each behavioral indicator computed deterministically from at least one of temporal score patterns, variance measures, and risk signal distributions;
mapping the at least one behavioral indicator to a discrete behavioral state selected from a group consisting of STABLE, DEGRADING, UNSTABLE, HIGH_RISK, and LOW_CONFIDENCE, using deterministic threshold-based mapping rules; and
transmitting, by a governance integration interface, the discrete behavioral state and at least one of the activity-level score, the final window score, the drift severity value, and the at least one behavioral indicator to a downstream governance platform via at least one of an application programming interface, a webhook, and a message queue, wherein the discrete behavioral state is consumable by the downstream governance platform to trigger at least one automated enforcement action.
